(19) United States
(12) Patent Application Publication
(10) Pub. No.: US 2015/0223042 A1
(43) Pub. Date: Aug. 6, 2015

(54) INDEPENDENT ROAMING CHARGING FOR A ROAMING USER EQUIPMENT IN A VISITED NETWORK

(71) Applicant: Alcatel Lucent, Boulogne Billancourt (FR)

(72) Inventor: Xiangyang Li, Shanghai (CN)

(73) Assignee: Alcatel Lucent, Boulogne Billancourt (FR)

(21) Appl. No.: 14/424,722

(22) PCT Filed: Aug. 26, 2013
(86) PCT No.: PCT/IB2013/002145

§ 371 Date: Feb. 27, 2015

(30) Foreign Application Priority Data
Aug. 31, 2012 (CN) 201210320748.0

(51) Int. Cl. H04W 4/24; H04W 8/02; H04M 15/00

(52) U.S. Cl. CPC H04W 4/24; H04M 15/8038; H04M 15/83; H04W 8/02; H04M 15/66; H04M 2215/34; H04W 84/042

(57) ABSTRACT

An objective of the present invention is to provide a method and apparatus for performing independent roaming charts for a roaming user equipment roaming in a VPLMN, a visited charging device acquires roaming service usage information of the roaming user equipment in the VPLMN from a visited PCEF, wherein the roaming user equipment roams to the VPLMN, and the visited charging device and the visited PCEF correspond to the VPLMN; the visited charging device determines roaming charging information of the roaming user equipment in the VPLMN based on a roaming charging policy, corresponding to the roaming user equipment, and the roaming service usage information. Compared with the prior art, the present invention provides an innovative policy and charging method, the roaming charging plan may be directly managed and controlled by the roaming operator in its own charging system, instead of being managed and controlled by the home operator, so as to support new EU roaming rules and meanwhile satisfy the requirements of the rules and of the operators.

### FIELD OF THE INVENTION

The present invention relates to the field of communication technology, and more specifically, relates to a technology of performing independent roaming charging for a roaming user equipment roaming in a visited public land mobile network (VPLMN).

### BACKGROUND OF THE INVENTION

When a roaming user equipment such as a mobile phone, a laptop or a tablet roams abroad, competitive data roaming offers will be opened up by the new EU roaming rules by introducing new ways of using these roaming user equipments. From July 2014, mobile network operators in visited countries will have the possibility to directly offer data roaming services in their own networks to roaming subscribers, while the roaming subscribers may select a mobile operator in advance or on the spot, while keeping the original phone number. The mobile network operators in visited countries will have an incentive to offer such services to the roaming subscriber based on lower network charges in the country of the roaming subscriber. The new EU rules introduce competition among roaming network operators and lower the expenses under the current roaming charging rules.

In the prior art, the existing packet data roaming can be categorized into two manners: home roaming and local roaming. For the home roaming, a serving Gateway (S-GW) is located in VPLMN, while a packet data gateway (P-GW) is located in a home public land mobile network (HPLMN). When an end user starts using data services in the VPLMN, the S-GW in the VPLMN will route the data communication back to the P-GW in the HPLMN. So data service is still provided via P-GW in the HPLMN. For the local roaming, both the serving gateway (S-GW) and the packet data gateway (P-GW) are in the home network. When an end user starts using a data service, the S-GW in the VPLMN will directly route the data communication back to the P-GW in the VPLMN. In the local roaming model, the visited operator's network (i.e., VPLMN) directly brings the data communication to the final destination.

However, from the perspective of charging, the data roaming charging for the home roaming and local roaming is still in an online charging system (OCS) of the HPLMN, instead of the VPLMN. The home operator provides a roaming charging plan for the end user, not that the visited operator provides a charging plan to the end user in the VPLMN which is provided to the roaming user by the operator per se.

To support the new EU roaming rules, most EU operators are urgently asking for solutions supporting those new rules.

Currently, most operators adopt a roaming with home routed access, where PGW or GGSN are deployed in an HPLMN; the PGW and GGSN in the HPLMN will trigger a charging request towards the OCS in the HPLMN.

The local-roaming model has not been widely deployed in the current market deployment yet. One reason thereof is that a home operator provides a permission for the home subscriber to use the roaming access network, but data communication still goes through the HPLMN; in this way, the home operator dominates and controls the roaming data communication in HPLMN to obtain more revenues and offers a roaming charging plan to the end user.

Under the pressure of reducing roaming price according to the new EU rules, competition between operators in roaming countries arises. Most operators prefer deploying the roaming network under local breakout. Thus, the operators in the roaming countries may directly control the roaming data communication by themselves; likewise, the operators can lower the network cost and need not route the data communication back to HPLMN.

However, according to the existing 3GPP policy and charging control architecture, the 3GPP TS 23.203 and 23.401 standards still simply adopt the existing home-roaming charging model. Use of the local-roaming data is still charged in the online charging system of the HPLMN. Therefore, the existing PCC architecture cannot well adopt the new EU regulations, i.e., unable to support the mobile operators of visited countries to directly provide, in their own networks, a data roaming service and plan to a roaming subscriber.

### SUMMARY OF THE INVENTION

An objective of the present invention is to provide a method and apparatus for performing independent roaming charging for a roaming user equipment roaming in a VPLMN.

According to one aspect of the present invention, there is provided a method for performing independent roaming charging for a roaming user equipment roaming in a VPLMN, wherein the method comprises the following steps:

a. a visited charging device acquires roaming service usage information of the roaming user equipment in the VPLMN from a visited PCEF, wherein the roaming user equipment roams to the VPLMN, and the visited charging device and the visited PCEF correspond to the VPLMN;

b. the visited charging device determines roaming charging information of the roaming user equipment in the VPLMN based on a roaming charging policy, corresponding to the roaming user equipment, and the roaming service usage information.

Preferably, the visited charging device comprises a visited online charging device, wherein the method further comprises the following steps:
a visited PCRF corresponding to the VPLMN acquires policy counter status information corresponding to the roaming user equipment from the visited online charging device through an Sy interface;
the visited PCRF establishes or updates a policy and charging control rule corresponding to the roaming user equipment based on the policy counter status information and sends it to the visited PCEF;
the visited PCEF provides network traffic, corresponding to the policy and charging control rule, to the roaming user equipment based on the policy and charging control rule.

According to another aspect of the present invention, there is further provided a visited charging device for performing independent roaming charging for a roaming user equipment roaming in a VPLMN, wherein the visited charging device comprises:

a service acquiring module configured to acquire roaming service usage information of the roaming user equipment in the VPLMN from a visited PCEF, wherein the roaming user equipment roams to the VPLMN, and the visited charging device and the visited PCEF correspond to the VPLMN;

a charging determining module configured to determine roaming charging information of the roaming user equipment in the VPLMN based on a roaming charging policy, corresponding to the roaming user equipment, and the roaming service usage information.

According to another aspect of the present invention, there is further provided a visited PCRF for facilitating independent charging for a roaming user equipment roaming in a VPLMN, wherein the visited PCRF comprises:

an information acquiring module configured to acquire policy counter status information corresponding to the roaming user equipment from a visited online charging device through an Sy interface, wherein the roaming user equipment roams to the VPLMN, and the visited online charging device and the visited PCRF correspond to the VPLMN;

a policy determining module configured to establish or update a policy and charging control rule corresponding to the roaming user equipment based on the policy counter status information and send it to the visited PCEF.

According to another aspect of the present invention, there is further provided a visited PCEF for facilitating independent roaming charging for a roaming user equipment roaming in the VPLMN, wherein the visited PCEF comprises:

a traffic providing module configured to provide network traffic corresponding to the policy and charging control rule to the roaming user equipment based on a policy and charging control rule of the roaming user equipment received from the visited PCRF, wherein the roaming user equipment roams to the VPLMN, and the visited PCEF and the visited PCRF correspond to the visited VPLMN;

a service usage determining module configured to determine roaming service usage information of the roaming user equipment in the VPLMN according to the network traffic;

a service usage providing module configured to provide the roaming service usage information for a visited charging device corresponding to the VPLMN.

According to another aspect of the present invention, there is further provided a system for performing independent roaming charging for a roaming user equipment roaming in a VPLMN, comprising a visited charging device above, a visited PCRF above, and a visited PCEF above.

Compared with the prior art, the present invention provides an innovative policy and charging method so as to support new EU roaming rules and meanwhile satisfy the requirements of the rules and of the operators, which allows a mobile operator in a visited country to directly offer a roaming charging plan to a roaming subscriber. The roaming subscriber will likewise directly select a more inexpensive roaming mobile network in the visited country. The new roaming charging plan may be directly managed and controlled by the roaming operator in its own charging system, instead of being managed and controlled by the home operator, which will enable operators to provide competitive roaming plans to attract the roaming subscriber to use their networks. The present invention likewise supports overheads restriction control and QoS control, so as to avoid “bill shock,” which greatly blocks over consumption of the roaming user in the VPLMN. Compared with the roaming charging mechanism executed by the home operator in the prior art, the present invention has a better technical effect.

### BRIEF DESCRIPTION OF THE DRAWINGS

Through reading the depictions on the non-limiting embodiments with reference to the following drawings, other features, objectives, and advantages of the present invention will become more apparent:

FIG. 1 shows a topological diagram of a system for performing independent roaming charging to a roaming user equipment roaming in a VPLMN according to one aspect of the present invention;

FIG. 2 shows a flowchart of a method for performing independent roaming charging to a roaming user equipment roaming in a VPLMN according to one aspect of the present invention;

FIG. 3 shows a flowchart of a method for performing independent roaming charging to a roaming user equipment roaming in a VPLMN according to one preferred embodiment of the present invention;

FIG. 4 shows a diagram of an apparatus for performing independent roaming charging to a roaming user equipment roaming in a VPLMN according to one aspect of the present invention;

In the accompanying drawings, same or like reference numerals represent same or corresponding components.

### DETAILED DESCRIPTION OF THE PREFERRED EMBODIMENTS

Hereinafter, the present invention will be depicted further in detail with reference to the accompanying drawings.

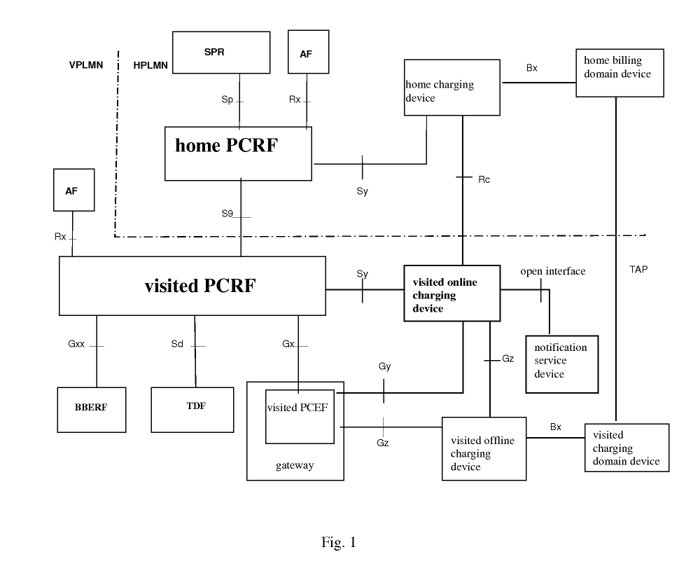

FIG. 1 shows a topological diagram of a system for performing independent roaming charging to a roaming user equipment roaming in a VPLMN according to one aspect of the present invention.

The system comprises a visited public land mobile network (VPLMN) and a home public land mobile network (HPLMN). The HPLMN comprises a subscription profile repository (SPR), a service policy providing point function (Application Function, AF), a home policy and charging rules function (H-PCRF), a home online charging system (H-OCS), and a home billing domain device; the VPLMN comprises a service policy providing point function (Application Function, AF), a bearing binding and event report function (BBERF), a traffic detection function (TDF), a visited policy and charging rules function (V-PCRF), a visited policy and charging enforcement function (B-PCEF), a visited online charging system (V-OCS), a visited offline charging system (V-OFCS), and a visited billing domain device.

Here, the roaming user equipment includes, but not limited to, a mobile phone, a laptop, or a tablet, which roams into the VPLMN. Those skilled in the art should understand that other existing or future possibly evolved roaming user equipment, if applicable to the present invention, should also be included within the protection scope of the present invention and is incorporated here by reference.

Here, the present invention introduces an online charging device for local breakout; thus, roaming operators may provide a roaming charging plan in their own networks to a roaming user and enforce a consumption limitation control and a policy control in their own networks.

The present invention likewise enables a roaming user to conduct roaming consumption in the roaming country and to roaming register the roaming mobile device in the visited online charging device, which will be different from their home mobile providers. For example, a temporary account file of the roaming user equipment will be created in the visited PCRF and visited charging device. The visited PCRF and visited charging device may set an account life cycle and allowed services, and the like.

The present invention introduces a Rc interface between the visited charging device and the home charging device, both of which can communicate via the Rc interface. Thus, the roaming user may use, in the home charging device, an account balance to buy roaming products in the visited charging device. The visited charging device will reserve and deduct the roaming charging from the home charging device.

The present invention likewise provides a flexible payment mechanism. A roaming user in the roaming country may use a credit card, a debit card, or a prepaid card of the roaming operator to purchase a roaming product in the visited charging device. In this case, the home charging device and the visited charging device do not need interactive communication there between.

The present invention introduces consumption cap based on a local breakout policy control. A Sy interface is introduced between a visited online charging device and a visited PCRF, both of which may communicate via the Sy interface. For example, when reaching the consumption cap, the network speed of the roaming country will be limited.

The present invention enables a consumption cap control capability in the visited charging device to avoid the case of “bill shock” when the roaming user travels to the roaming country. When the consumption cap is reached, the visited charging device will send an alarm to the roaming user based on a preset charging threshold. The roaming user may select whether to continue purchasing the roaming product.

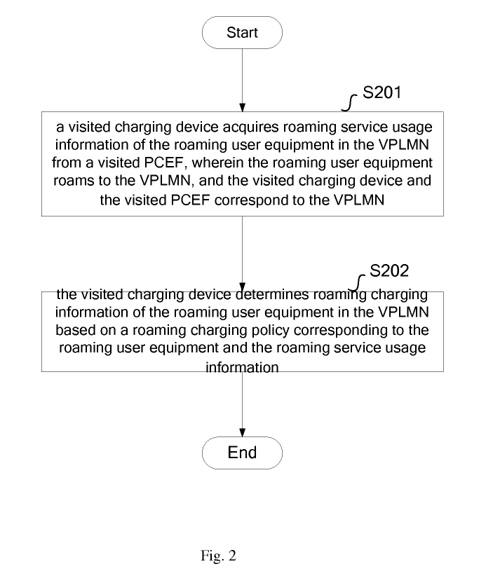

FIG. 2 shows a flowchart of a method for performing independent roaming charging to a roaming user equipment roaming in a VPLMN according to one aspect of the present invention.

In step S201, the visited charging device obtains, from a visited PCEF, roaming service usage information of a roaming user equipment in VPLMN, wherein the roaming user equipment roams to the VPLMN, and the visited charging device and the visited PCEF correspond to the VPLMN. Specifically, when the roaming user equipment roams to VPLMN, the visited charging device in the VPLMN obtains, from the visited PCEF in the VPLMN, the roaming service usage information of the roaming user equipment in the VPLMN via a Gy interface. For example, the visited PCEF voluntarily sends the roaming service usage information to the visited charging device, or the visited charging device sends an information request to the visited PCEF, and a particular field of the information request, for example, includes a device identification of the roaming user equipment, then the visited PCEF returns the roaming service usage information of the roaming user equipment back to the visited charging device based on the information request.

Here, the visited charging device may be a visited online charging device, for example, a visited online charging system (v_OCS), or a visited offline charging device, for example, a visited offline charging system (v-OFCS), and the like.

Here, the roaming service usage information includes, but not limited to, a corresponding mobile station roaming number (MSRN) of the roaming user equipment in the VPLMN, an international mobile subscriber identifier (IMSI), a mobile station international ISDN number (MSISDN), a call duration and/or traffic usage, and the like.

Those skilled in the art should understand that the above roaming service usage information is only exemplary, and other existing or future possibly evolved roaming service usage information, if applicable to the present invention, should also be included within the protection scope of the present invention and is incorporated here by reference.

In step S202, the visited charging device determines roaming charging information of the roaming user equipment in the VPLMN based on a roaming charging policy, corresponding to the roaming user equipment, and the roaming service usage information. Specifically, the visited charging device determines the roaming charging information of the roaming user equipment in the VPLMN based on a roaming charging policy corresponding to the roaming user equipment, for example, a roaming charging policy such as the roaming package, price and the like selected by the roaming user as stored by the roaming user equipment in the visited charging device, as well as and roaming service usage information such as the mobile station roaming number (MSRN), the international mobile user identifier (IMSI), mobile station international ISDN number (MSISDN), call duration and/or traffic usage corresponding to the roaming user equipment in the VPLMN.

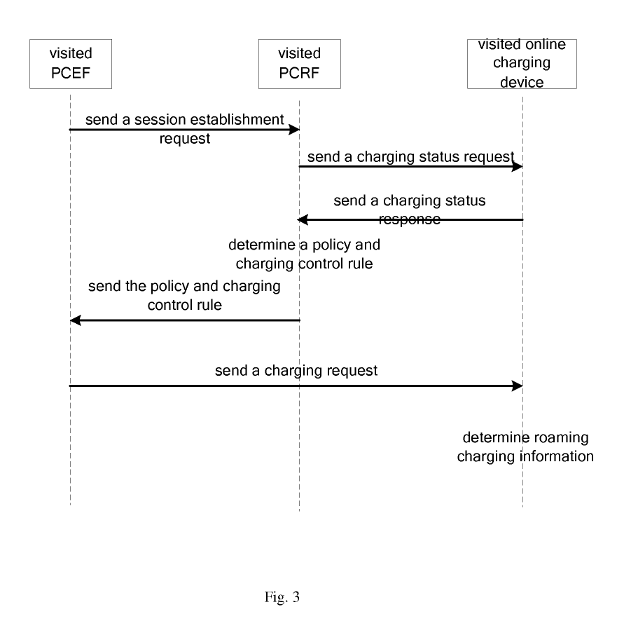

FIG. 3 shows a flowchart of a method for performing independent roaming charging to a roaming user equipment roaming in a VPLMN according to one preferred embodiment of the present invention. This figure shows the part of flow that performs roaming charging to the roaming user equipment when the roaming user equipment roams to VPLMN. Those skilled in the art should understand that other functions or steps not shown should also be included within the protection scope of the present invention and is incorporated here by reference.

With reference to FIG. 3, 1) the visited PCEF in the VPLMN sends a session establishment request to the visited PCRF for example through a Gx interface, a specific field of which session establishment request for example comprises a device identification of the roaming user equipment;

2) The visited PCRF sends to the visited online charging device in the visited VPLMN a charging status request based on the device identification via the Sy interface;

3) The visited online charging device sends a charging status response to the visited PCRF so as to return the account information of the roaming user equipment;

4) The visited PCRF generates a policy and charging control rule based on the account information of the roaming user equipment;

5) The visited PCRF sends the policy and charging control rule to the visited PCEF through a Gx interface;

6) The visited PCEF performs the policy and charging control rule and sends a charging request to the visited online charging device through a Gy interface, which charging request for example comprises roaming service usage information of the roaming user equipment in the VPLMN;

7) The visited charging device determines roaming charging information of the roaming user equipment in the VPLMN based on the roaming charging policy of the roaming user equipment such as roaming package, price and the like and the roaming service usage information of the roaming user equipment.

For example, the roaming user equipment roams to Country A in which there are a plurality of operators. The roaming user corresponding to the roaming user equipment selects one operator thereof. Then the visited PCEF in the VPLMN of the operator, for example through a Gx interface, sends a session establishment request to the visited PCRF. A special field of the session establishment request for example comprises a device identification of the roaming user equipment. The visited PCRF requests the visited online charging device in the VPLMN for the account information of the roaming user equipment based on the device identification via the Sy interface and generated a policy and charging control rule based on the acquired account information, and sends the policy and charging control rule to the visited PCEF through the Gx interface. The visited PCEF enforces the policy and charging control rule and sends the charging request to the visited online charging device through a Gy interface, which charging request for example includes the roaming service usage information of the roaming user equipment in the VPLMN, which roaming service usage information includes, but not limited to, the mobile station roaming number (MS RN), the international mobile subscriber identifier (IMSI), the mobile station international ISDN number (MSISDN), call duration and/or traffic usage, and other information corresponding to the roaming user equipment in the VPLMN. The visited charging device determines the roaming charging information of the roaming user equipment in the VPLMN based on the roaming charging policy of the roaming user equipment such as roaming package, price, and the like, as well as one or more of the above roaming service usage information.

Preferably, the visited charging device comprises a visited online charging device, wherein the visited PCRF corresponding to the VPLMN acquires the policy counter status information corresponding to the roaming user equipment from the visited online charging device through an Sy interface; the visited PCRF establishes or updates the policy and charging control rule corresponding to the roaming user equipment based on the policy counter status information, and sends it to the visited PCEF; based on the policy and charging control rule, the visited PCEF provides network traffic corresponding to the policy and charging control rule to the roaming user equipment.

Specifically, the visited PCRF corresponding to the visited VPLMN acquires the policy counter status information corresponding to the roaming user equipment from the visited online charging device, which policy counter status information includes, but not limited to, account status information, predetermined charging threshold, predetermined account threshold and the like of the roaming user equipment. Here, the account status information includes for example the roaming package, traffic usage, or account balance information of the roaming user equipment, etc.

For example, when the roaming user equipment just roams into the VPLMN, the visited PCRF acquires policy counter status information such as the account information of the roaming user equipment from the visited online charging device through the Sy interface. Afterwards, the visited PCRF establishes a policy and charging control rule corresponding to the roaming user equipment based on the policy counter status information, and sends it to the visited PCEF in the VPLMN through the Gx interface. The visited PCEF requests the visited online charging device for a predetermined limit of network traffic based on the policy and charging control rule through the Gy interface.

Here, the visited online charging device may also respond to a policy status request of the visited PCRF to further send the policy counter status information; or, the visited online charging device may sends the policy counter status information to the visited PCRF periodically or based a predetermined trigger condition.

For example, when the roaming charging information of the roaming user equipment as determined by the visited online charging device exceeds a predetermined threshold, or, when the roaming user equipment's account balance in the visited online charging device is insufficient, the visited online charging device sends the policy counter status information to the visited PCRF through the Sy interface. Here, the policy counter status information, for example, may be represented in a numerical value form, for example, using a numerical value to represent the traffic usage and account balance information and the like of the roaming user equipment.

Afterwards, the visited PCRF updates the policy and charging control rule corresponding to the roaming user equipment based on the policy counting status information, and sends the updated policy and charging control rule to the visited PCEF; the visited PCEF requests the visited online charging device for a predetermined limit of network traffic based on the updated policy and charging control rule through the Gy interface.

Preferably, the visited PCEF determines the roaming service usage information of the roaming user equipment in the VPLMN based on the network traffic provided to the roaming user equipment; wherein the visited charging device acquires the roaming service usage information from the visited PCEF, wherein the roaming user equipment roams to the VPLMN, and the visited charging device and the visited PCEF correspond to the VPLMN. Here, the roaming user equipment uses a predetermined limit of network traffic. The visited PCEF determines the roaming service usage information of the roaming user equipment in the VPLMN based on the network traffic used by the roaming user equipment. Afterwards, the visited charging device acquires the roaming service usage information from the visited PCEF and determines the roaming charging information of the roaming user equipment based thereupon.

In one embodiment, the visited charging device performs roaming settlement processing for the roaming user equipment based on the roaming charging information in conjunction with the account information of the roaming user equipment in the visited charging device. Specifically, after the visited charging device determines the roaming charging information of the roaming user equipment, the visited charging device directly performs the roaming settlement processing for the roaming user equipment in the visited charging device based on the roaming charging information in conjunction with the account information of the roaming user equipment in the visited charging device, for example, performing charging processing for the roaming user equipment, etc. The roaming subscriber, for example, may use a credit card or a debit card to purchase a corresponding roaming product; or, the roaming subscriber purchases a roaming product by purchasing a prepayment card provided by the roaming operator corresponding to the VPLMN. This roaming product, for example, may a one-day, three-day, five-day, or seven-day roaming plan or a monthly roaming plan, or a summer vocation roaming plan, etc.

In another embodiment, the visited charging device sends a settlement processing request to a home charging device corresponding to the roaming user equipment, wherein the settlement processing request comprises roaming charging information of the roaming user equipment; the home charging device performs settlement processing for the roaming user equipment based on the settlement processing request in conjunction with the account information of the roaming user equipment in the home charging device. Here, the visited charging device performs interaction operation through a home charging device corresponding to the home public land mobile network (HPLMN) corresponding to the roaming user equipment, and performs the settlement processing for the roaming user equipment in the home charging device. Specifically, the visited charging device sends a settlement processing request to the home charging device corresponding to the roaming user equipment for example through the Re interface, wherein a special field of the settlement processing request, for example, may comprise a device identification of the roaming user equipment, the roaming charging information of the roaming user equipment, and the like; the home charging device performs settlement processing for the roaming user equipment, for example, performing charging processing from the account balance of the roaming user equipment at the home charging device, based on the settlement processing request in conjunction with the account information of the roaming user equipment in the home charging device, for example, by extracting the device identification and roaming charging information of the roaming user equipment from a special field of the settlement processing request. If the HPLMN uses a different currency from the VPLMN, the home charging device would perform exchange processing to the roaming charging information sent from the visited charging device, so as to perform processing such as maintaining and deducting the currency of the home operator corresponding to the HPLMN.

Preferably, when a trigger condition is satisfied, the visited charging device sends a charging notification regarding the roaming user equipment to a notification service device corresponding to the roaming user equipment. The notification service device sends the charging notification to the roaming user equipment so as to notify the roaming user equipment, wherein the trigger condition includes at least one of the following items:
the roaming charging information exceeds a predetermined charging threshold;
the account information of the roaming user equipment is lower than a predetermined account threshold.

Specifically, the visited charging device performs roaming charging to the roaming user equipment and maintains account information for the roaming user equipment. When the roaming charging information of the roaming user equipment exceeds a predetermined charging threshold, or when the account information corresponding to the roaming user equipment is lower than a predetermined account threshold, the visited charging device sends a charging notification regarding the roaming user equipment to a notification service device (e.g., a notification server) corresponding to the roaming user equipment through an open interface, which charging notification for example may comprise roaming charging information and account balance information and the like of the roaming user equipment. Then, the notification service device sends the charging notification to the roaming user equipment so as to notify the roaming user equipment that its roaming charging information has exceeded a predetermined charging threshold, or, its account balance is insufficient, etc. Here, the open interface may be based on any protocol, for example, LDAP, TCPIP, HTTP/XML, MAP, SMTP, and other protocols, to transmit the charging notification to the notification service device. The notification service device may send the charging notification to the roaming user equipment for example through a common SMS, a multimedia messaging service (MMS), an instant message, email, and the like.

Here, the present invention sends the charging notification to the roaming user equipment such that the roaming user equipment can effectively avoid circumstances such as “bill shock.”

Preferably, the visited charging device comprises a visited online charging device, wherein the charging notification includes one or more roaming charging plans, wherein the visited online charging device acquires a target roaming charging plan selected by the roaming subscriber corresponding to the roaming user equipment from among the one or more roaming charging plans, and sends it to the visited PCRF; the visited PCRF updates the policy and charging control rule based on the target roaming charging plan, and sends the updated policy and charging control rule to the visited PCEF; the visited PCEF provides the network traffic corresponding to the updated policy and charging control rule to the roaming user equipment based on the updated policy and charging control rule.

Specifically, the visited charging device comprises a visited online charging device. In the charging notification provided to the roaming user equipment, for example, there may include one or more roaming charging plans, such as whether to continue payment, suspend payment, purchase a new roaming charging plan, and the like, from among which the roaming subscriber selects a target roaming charging plan. Afterwards, the visited online charging device acquires the target roaming charging plan selected by the roaming subscriber and sends the target roaming charging plan to the visited PCRF through an Sy interface. After receiving the target roaming charging plan, the visited PCRF updates the policy and charging control rule based on the target roaming charging plan selected by the roaming subscriber, and sends the updated policy and charging control rule to the visited PCEF through a Gx interface. The visited PCEF request the visited online charging device for a predetermined limit of network traffic based on the updated policy and charging control rule through a Gy interface.

For example, if the account balance information of the roaming user equipment is lower than a predetermined account threshold, while the roaming subscriber chooses not to continue payment, the visited PCRF determines to suspend the service for the roaming user equipment.

For another example, if the account balance information of the roaming user equipment is lower than a predetermined account threshold, or, the roaming charging information of the roaming user equipment exceeds the predetermined charging threshold, while the roaming subscriber chooses to lower the network QoS or lower the network speed and continue the roaming service at an overage tariff price, then the visited PCRF re-determines a new policy and charging control rule for the roaming user equipment and sends it to the visited PCEF. The new policy and charging control rule is enforced by the visited PCEF to lower the network QoS.

For another example, if the account balance information of the roaming user equipment is lower than a predetermined account threshold, while the roaming subscriber chooses to purchase another new roaming charging plan, the visited PCRF re-determines a policy and charging control rule for the roaming user equipment based on the new roaming charging plan.

The visited charging device may further request the home charging device to maintain more account balance such that the roaming user equipment continues the current session. Once the session ends, the visited charging device will refund the remaining unused funds to the home charging device. When the service data flow is charged, the visited charging device may also report the local taxation information so as to reflect the local overall charging situation.

Preferably, the visited charging device sends the roaming charging information to the visited billing domain device in the VPLMN; the visited billing domain device generates roaming bill information of the roaming user equipment based on the roaming charging information and sends it to the roaming user equipment. Specifically, the visited charging device, after determining the roaming charging information of the roaming user equipment, sends roaming charging information to the visited billing domain device in the VPLMN, for example, in a form of charging data record (CDR) file; the visited billing domain device, generates the roaming bill information of the roaming user equipment based on the roaming charging information, for example, each time the roaming user equipment makes a call, generating roaming bill information once, or generating roaming bill information once for the roaming user equipment periodically, for example, daily, weekly, monthly, etc., or, generating roaming bill information once for the roaming user equipment when the roaming charging information of the roaming user equipment exceeds the predetermined charging threshold or when the account balance information is lower than a predetermined account threshold, and sending the roaming bill information to the roaming user equipment.

More preferably, the visited billing domain device generates account transfer information of the roaming user equipment based on the roaming charging information in conjunction with roaming relevant information of the roaming user equipment in the VPLMN, and sends it to the home billing domain device corresponding to the roaming user equipment; wherein the home billing domain device generates roaming bill information of the roaming user equipment based on the account transfer information and sends it to the roaming user equipment.

Specifically, the visited billing device, after receiving the roaming charging information of the roaming user equipment sent from the visited charging device, generates account transfer information of the roaming user equipment, the account transfer information for example being in a form of TAP (transferred accounts procedure), further in conjunction with the roaming relevant information such as traffic usage condition, price, exchange rate, and the like of the roaming user equipment in the VPLMN, and sends the account transfer information to the home billing domain device corresponding to the roaming user equipment, for example, sending it to the home billing domain device of the user equipment in HPLMN. Afterwards, the home billing domain device generates a roaming bill for the roaming user equipment based on the account transfer information and provides it to the roaming user equipment. Here, the home charging domain device, for example, generates roaming bill information once for the roaming user equipment each time it receives account transfer information from the visited billing domain device; or periodically, for example, daily, weekly, monthly, etc., generates roaming bill information once for the roaming user equipment. For example, even if the home billing domain device receives account transfer information from the visited billing domain device for multiple times in one month, it still generates roaming bill information once for the roaming user equipment at the end of the month and sends the roaming bill information to the roaming user equipment.

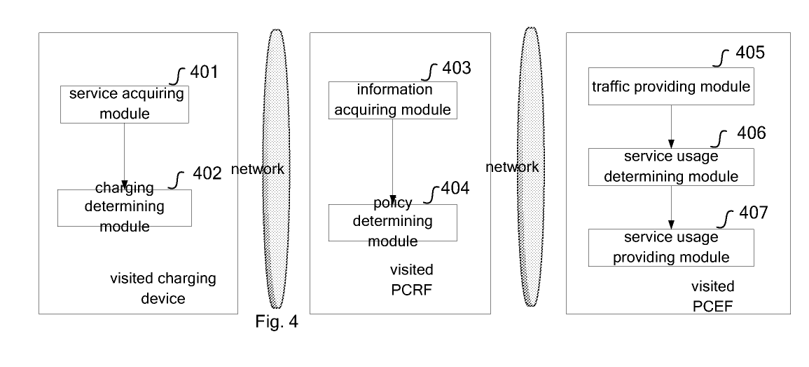

FIG. 4 shows a diagram of an apparatus for performing independent roaming charging for a roaming user equipment roaming in VPLMN according to one aspect of the present invention. The visited charging device comprises a service acquiring module 401 and a charging determining module 402; the visited PCRF comprises an information acquiring module 403 and a policy determining module 404; the visited PCEF comprises a traffic providing module 405, a service usage determining module 406, and a service usage providing module 407.

Wherein, the service acquiring module 401 in the visited charging device obtains, from a visited PCEF, roaming service usage information of a roaming user equipment in VPLMN, wherein the roaming user equipment roams to the VPLMN, and the visited charging device and the visited PCEF correspond to the VPLMN.

Specifically, when the roaming user equipment roams to VPLMN, the service acquiring module 401 in the visited charging device in the VPLMN obtains, from the visited PCEF in the VPLMN, the roaming service usage information of the roaming user equipment in the VPLMN via a Gy interface. For example, the visited PCEF voluntarily sends the roaming service usage information to the visited charging device, or the service acquiring module 401 in the visited charging device sends an information request to the visited PCEF, and a particular field of the information request, for example, includes a device identification of the roaming user equipment, then the visited PCEF returns the roaming service usage information of the roaming user equipment back to the visited charging device based on the information request.

Here, the visited charging device may be a visited online charging device, for example, a visited online charging system (v_OCS), or a visited offline charging device, for example, a visited offline charging system (v-OFCS), and the like.

Here, the roaming service usage information includes, but not limited to, a corresponding mobile station roaming number (MSRN) of the roaming user equipment in the VPLMN, an international mobile subscriber identifier (IMSI), a mobile station international ISDN number (MSISDN), a call duration and/or traffic usage, and the like.

Those skilled in the art should understand that the above roaming service usage information is only exemplary, and other existing or future possibly evolved roaming service usage information, if applicable to the present invention, should also be included within the protection scope of the present invention and is incorporated here by reference.

The charging determining module 402 in the visited charging device determines roaming charging information of the roaming user equipment in the VPLMN based on a roaming charging policy, corresponding to the roaming user equipment, and the roaming service usage information.

Specifically, the charging determining module 402 in the visited charging device determines the roaming charging information of the roaming user equipment in the VPLMN based on a roaming charging policy corresponding to the roaming user equipment, for example, a roaming charging policy such as the roaming package, price and the like selected by the roaming user as stored by the roaming user equipment in the visited charging device, as well as and roaming service usage information such as the mobile station roaming number (MSRN), the international mobile user identifier (IMSI), mobile station international ISDN number (MSISDN), call duration and/or traffic usage corresponding to the roaming user equipment in the VPLMN.

Preferably, the visited charging device further comprises settlement processing module (not shown). The settlement processing module in the visited charging device performs roaming settlement processing for the roaming user equipment based on the roaming charging information in conjunction with the account information of the roaming user equipment in the visited charging device.

Specifically, after the charging determining module 402 in the visited charging device determines the roaming charging information of the roaming user equipment, the settlement processing module in the visited charging device directly performs the roaming settlement processing for the roaming user equipment in the visited charging device based on the roaming charging information in conjunction with the account information of the roaming user equipment in the visited charging device, for example, performing charging processing for the roaming user equipment, etc. The roaming subscriber, for example, may use a credit card or a debit card to purchase a corresponding roaming product; or, the roaming subscriber purchases a roaming product by purchasing a prepayment card provided by the roaming operator corresponding to the VPLMN. This roaming product, for example, may a one-day, three-day, five-day, or seven-day roaming plan or a monthly roaming plan, or a summer vocation roaming plan, etc.

The information acquiring module 403 in the visited PCRF acquires the policy counter status information corresponding to the roaming user equipment from the visited online charging device through an Sy interface, wherein the roaming user equipment roams to the VPLMN, and the visited charging device and the visited PCEF correspond to the VPLMN.

Specifically, the information acquiring module 403 in the visited PCRF corresponding to the visited VPLMN acquires the policy counter status information corresponding to the roaming user equipment from the visited online charging device, which policy counter status information includes, but not limited to, account status information, predetermined charging threshold, predetermined account threshold and the like of the roaming user equipment. Here, the account status information includes for example the roaming package, traffic usage, or account balance information of the roaming user equipment, etc.

The policy determining module 404 in the visited PCRF establishes or updates the policy and charging control rule corresponding to the roaming user equipment based on the policy counter status information, and sends it to the visited PCEF.

For example, when the roaming user equipment just roams into the VPLMN, the information acquiring module 403 in the visited PCRF acquires policy counter status information such as the account information of the roaming user equipment from the visited online charging device through the Sy interface. Afterwards, the policy determining module 404 in the visited PCRF establishes a policy and charging control rule corresponding to the roaming user equipment based on the policy counter status information, and sends it to the visited PCEF in the VPLMN through the Gx interface.

Here, the visited online charging device may also respond to a policy status request of the visited PCRF to further send the policy counter status information; or, the visited online charging device may sends the policy counter status information to the visited PCRF periodically or based a predetermined trigger condition.

For example, when the roaming charging information of the roaming user equipment as determined by the visited online charging device exceeds a predetermined threshold, or, when the roaming user equipment's account balance in the visited online charging device is insufficient, the visited online charging device sends the policy counter status information to the visited PCRF through the Sy interface. Here, the policy counter status information, for example, may be represented in a numerical value form, for example, using a numerical value to represent the traffic usage and account balance information and the like of the roaming user equipment.

Afterwards, the policy determining module 404 in the visited PCRF updates the policy and charging control rule corresponding to the roaming user equipment based on the policy counting status information, and sends the updated policy and charging control rule to the visited PCEF; the traffic providing module 405 in the visited PCEF requests the visited online charging device for a predetermined limit of network traffic based on the updated policy and charging control rule through the Gy interface.

Preferably, the visited PCRF further comprises a policy updating module (not shown). The policy updating module updates the policy and charging control rule based on the target roaming charging plan of the roaming user equipment as received from the visited online charging device, and sends the updated policy and charging control rule to the visited PCEF.

Specifically, the visited charging device comprises a visited online charging device. In the charging notification provided to the roaming user equipment, for example, there may include one or more roaming charging plans, such as whether to continue payment, suspend payment, purchase a new roaming charging plan, and the like, from among which the roaming subscriber selects a target roaming charging plan. Afterwards, the visited online charging device acquires the target roaming charging plan selected by the roaming subscriber and sends the target roaming charging plan to the visited PCRF through an Sy interface. After receiving the target roaming charging plan, the policy updating module in the visited PCRF updates the policy and charging control rule based on the target roaming charging plan selected by the roaming subscriber, and sends the updated policy and charging control rule to the visited PCEF through a Gx interface. The visited PCEF request the visited online charging device for a predetermined limit of network traffic based on the updated policy and charging control rule through a Gy interface.

For example, if the account balance information of the roaming user equipment is lower than a predetermined account threshold, while the roaming subscriber chooses not to continue payment, the policy updating module in the visited PCRF determines to suspend the service for the roaming user equipment.

For another example, if the account balance information of the roaming user equipment is lower than a predetermined account threshold, or, the roaming charging information of the roaming user equipment exceeds the predetermined charging threshold, while the roaming subscriber chooses to lower the network QoS or lower the network speed and continue the roaming service at an overage tariff price, then the policy updating module in the visited PCRF re-determines a new policy and charging control rule for the roaming user equipment and sends it to the visited PCEF. The new policy and charging control rule is enforced by the visited PCEF to lower the network QoS.

For another example, if the account balance information of the roaming user equipment is lower than a predetermined account threshold, while the roaming subscriber chooses to purchase another new roaming charging plan, the policy updating module in the visited PCRF re-determines a policy and charging control rule for the roaming user equipment based on the new roaming charging plan.

The visited charging device may further request the home charging device to maintain more account balance such that the roaming user equipment continues the current session. Once the session ends, the visited charging device will refund the remaining unused funds to the home charging device. When the service data flow is charged, the visited charging device may also report the local taxation information so as to reflect the local overall charging situation.

The traffic providing module 405 in the visited PCEF, based on a policy and charging control rule of the roaming user equipment received from the visited PCRF, provides network traffic corresponding to the policy and charging control rule to the roaming user equipment, wherein the roaming user equipment roams to the VPLMN, and the visited PCEF and the visited PCRF correspond to the VPLMN.

The service usage determining module 406 in the visited PCEF determines roaming service usage information of the roaming user equipment in the VPLMN based on the network traffic provided to the roaming user equipment. Here, the roaming user equipment uses a predetermined limit of network traffic. The service usage determining module 406 in the visited PCEF determines roaming service usage information of the roaming user equipment in the VPLMN based on the network traffic used by the roaming user equipment; then, the visited charging device acquires the roaming service usage information from the visited PCEF and determines the roaming charging information of the roaming user equipment based thereupon.

The service usage providing module 407 in the visited PCEF provides the roaming service usage information to the visited charging device corresponding to the VPLMN.

It should be noted that the present invention may be implemented in software and/or a combination of software and hardware, for example, it may be implemented by an application-specific integrated circuit ASIC, a general purpose computer or any other similar hardware device. In one embodiment, the software program of the present invention may be executed through a processor to implement the steps or functions as mentioned above. Likewise, the software program of the present invention (including relevant data structure) may be stored in the computer-readable recording medium, for example, RAM memory, magnetic or optic driver or flappy disk or similar devices. Besides, some steps or functions of the present invention may be implemented by hardware, for example, as a circuit cooperating with the processor to execute various steps or functions.

Besides, a part of the present invention may be applied as a computer program product, for example, a computer program instruction, which, when executed by a computer, through the operation of the computer, may invoke or provide the method and/or technical solution of the present invention. However, the program instruction invoking the method of the present invention may be stored in a fixed or mobile recording medium, and/or transmitted through a data stream in broadcast or other signal carrier medium, and/or stored in a working memory of a computer device running according to the program instruction. Here, one embodiment according to the present invention comprises an apparatus that includes a memory for storing computer program instructions and a processor for executing program instructions, wherein when the computer program instructions are executed by the processor, the apparatus is triggered to run the methods and/or technical solutions based on the previously mentioned multiple embodiments of the present invention.

To those skilled in the art, it is apparent that the present invention is not limited to the details of above exemplary embodiments, and the present invention can be implemented with other specific embodiments without departing the spirit or basic features of the present invention. Thus, from any perspective, the embodiments should be regarded as illustrative and non-limiting. The scope of the present invention is limited by the appended claims, instead of the above description. Thus, meanings of equivalent elements falling within the claims and all variations within the scope are intended to be included within the present invention. Any reference numerals in the claims should be regarded as limiting the involved claims. Besides, it is apparent that such terms as “comprise” and “include” do not exclude other units or steps, and a single form does not exclude a plural form. The multiple units or modules as stated in apparatus claims can also be implemented by a single unit or module through software or hardware. Terms such as first and second are used to represent names, not representing any specific sequence.

1. A method for performing independent roaming charging for a roaming user equipment roaming in a VPLMN, wherein the method:
a visited charging device acquires roaming service usage information of the roaming user equipment in the VPLMN from a visited PCEF, wherein the roaming user equipment roams to the VPLMN, and the visited charging device and the visited PCEF correspond to the VPLMN;
the visited charging device determines roaming charging information of the roaming user equipment in the VPLMN based on a roaming charging policy, corresponding to the roaming user equipment, and the roaming service usage information.

2. The method according to claim 1, wherein the visited charging device comprises a visited online charging device, wherein the method further comprises:
a visited PCRF corresponding to the VPLMN acquires policy counter status information corresponding to the roaming user equipment from the visited online charging device through an Sy interface;
the visited PCRF establishes or updates a policy and charging control rule corresponding to the roaming user equipment based on the policy counter status information and sends it to the visited PCEF;
the visited PCEF provides network traffic, corresponding to the policy and charging control rule, to the roaming user equipment based on the policy and charging control rule.

3. The method according to claim 2, wherein the method further comprises:
the visited PCEF determines roaming service usage information of the roaming user equipment in the VPLMN based on the network traffic;
wherein acquiring comprises:
the visited charging device acquires the roaming service usage information from the visited PCEF, wherein the roaming user equipment roams to the VPLMN, and the visited charging device and the visited PCEF correspond to the VPLMN.

4. The method according to claim 1, wherein the method further comprises:
the visited charging device performs roaming settlement processing for the roaming user equipment based on the roaming charging information in conjunction with account information of the roaming user equipment in the visited charging device.

5. The method according to claim 1, wherein the method further comprises:
the visited charging device sends a settlement processing request to a home charging device corresponding to the roaming user equipment, wherein the settlement processing request includes roaming charging information of the roaming user equipment;
the home charging device performs settlement processing for the roaming user equipment based on the settlement processing request in conjunction with account information of the roaming user equipment in the home charging device.

6. The method according to claim 1, wherein the method further comprises:
when a trigger condition is satisfied, the visited charging device sends a charging notification regarding the roaming user equipment to a notification service device corresponding to the roaming user equipment;
the notification service device sends the charging notification to the roaming user equipment so as to notify the roaming user equipment;
wherein the trigger condition comprises at least any one of the following items:
the roaming charging information exceeds a predetermined charging threshold;
the account information corresponding to the roaming user equipment is lower than a predetermined account threshold.

7. The method according to claim 6, wherein the charging notification includes one or more roaming charging plans, wherein the method further comprises:
the visited online charging device acquires a target roaming charging plan selected by a roaming subscriber corresponding to the roaming user equipment from among the one or more roaming charging plans, and sends it to the visited PCRF;
the visited PCRF updates the policy and charging control rule based on the target roaming charging plan and sends the updated policy and charging control rule to the visited PCEF;
the visited PCEF provides network traffic corresponding to the updated policy and charging control rule to the roaming user equipment based on the updated policy and charging control rule.

8. The method according to claim 1, wherein the method further comprises:
the visited charging device sends the roaming charging information to a visited billing domain device in the VPLMN;
the visited billing domain device generates roaming bill information of the roaming user equipment based on the roaming charging information, and sends it to the roaming user equipment.

9. The method according to claim 8, wherein the generating comprises:
the visited billing domain device generates account transfer information of the roaming user equipment based on the roaming charging information in conjunction with roaming relevant information of the roaming user equipment in the VPLMN, and sends it to a home billing domain device corresponding to the roaming user equipment;
wherein, the method further comprises:
the home billing domain device generates roaming bill information of the roaming user equipment based on the account transfer information, and sends it to the roaming user equipment.

10. A visited charging device for performing independent roaming charging for a roaming user equipment roaming in a VPLMN, wherein the visited charging device comprises:
a service acquiring module configured to acquire roaming service usage information of the roaming user equipment in the VPLMN from a visited PCEF, wherein the roaming user equipment roams to the VPLMN, and the visited charging device and the visited PCEF correspond to the VPLMN;
a charging determining module configured to determine roaming charging information of the roaming user equipment in the VPLMN based on a roaming charging policy, corresponding to the roaming user equipment, and the roaming service usage information.

11. The visited charging device according to claim 10, wherein the visited charging device further comprises:
a settlement processing module configured to perform roaming settlement processing for the roaming user equipment based on the roaming charging information in conjunction with account information of the roaming user equipment in the visited charging device.

12. A visited PCRF for facilitating independent charging for a roaming user equipment roaming in a VPLMN, wherein the visited PCRF comprises:
an information acquiring module configured to acquire policy counter status information corresponding to the roaming user equipment from a visited online charging device through an Sy interface, wherein the roaming user equipment roams to the VPLMN, and the visited online charging device and the visited PCRF correspond to the VPLMN;
a policy determining module configured to establish or update a policy and charging control rule corresponding to the roaming user equipment based on the policy counter status information and send it to the visited PCEF.

13. The visited PCRF corresponding to claim 12, wherein the visited PCRF further comprises:
a policy updating module configured to update the policy and charging control rule based on a target roaming charging plan of the roaming user equipment as received from the visited online charging device, and send the updated policy and charging control rule to the visited PCEF.

14. A visited PCEF for facilitating independent roaming charging for a roaming user equipment roaming in the VPLMN, wherein the visited PCEF comprises:
a traffic providing module configured to provide network traffic corresponding to the policy and charging control rule to the roaming user equipment based on a policy and charging control rule of the roaming user equipment received from the visited PCRF, wherein the roaming user equipment roams to the VPLMN, and the visited PCEF and the visited PCRF correspond to the visited VPLMN;
a service usage determining module configured to determine roaming service usage information of the roaming user equipment in the VPLMN according to the network traffic;
a service usage providing module configured to provide the roaming service usage information for a visited charging device corresponding to the VPLMN.

15. A system for performing independent roaming charging for a roaming user equipment roaming in a VPLMN, comprising a visited charging device according to claim 10, a visited PCRF comprising an information acquiring module configured to acquire policy counter status information corresponding to the roaming user equipment from a visited online charging device through an Sy interface, wherein the roaming user equipment roams to the VPLMN, and the visited online charging device and the visited PCRF correspond to the VPLMN and a policy determining module configured to establish or update a policy and charging control rule corresponding to the roaming user equipment based on the policy counter status information and send it to the visited PCEF, and a visited PCEF comprising a traffic providing module configured to provide network traffic corresponding to the policy and charging control rule to the roaming user equipment based on a policy and charging control rule of the roaming user equipment received from the visited PCRF, wherein the roaming user equipment roams to the VPLMN, and the visited PCEF and the visited PCRF correspond to the visited VPLMN, a service usage determining module configured to determine roaming service usage information of the roaming user equipment in the VPLMN according to the network traffic, and a service usage providing module configured to provide the roaming service usage information for a visited charging device corresponding to the VPLMN.
